(19) United States
(12) Patent Application Publication
(10) Pub. No.: US 2022/0115678 A1
(43) Pub. Date: Apr. 14, 2022

(54) HUMIDIFIER MODULE WITH STITCHED-IN FLOW FIELD, HUMIDIFIER, METHOD FOR MAKING A HUMIDIFIER MODULE AND METHOD FOR MAKING A HUMIDIFIER

(71) Applicants: AUDI AG, Ingolstadt (DE); VOLKSWAGEN AG, Wolfsburg (DE)

(72) Inventors: Rune STAECK, Gifhorn (DE); Felix ROTHE, Gifhorn (DE); Dirk JENSSEN, Braunschweig (DE); Martin BUCHENBERGER, Wendeburg (DE); Markus KÜHN, Isenbüttel (DE); Jan BEUSCHER, Braunschweig (DE); Sven HARTWIG, Braunschweig (DE)

(21) Appl. No.: 17/423,759

(22) PCT Filed: Dec. 3, 2019
(86) PCT No.: PCT/EP2019/083445

§ 371 Date: Jul. 16, 2021

(30) Foreign Application Priority Data
Jan. 16, 2019 (DE) 10 2019 200 451.2

(51) Int. Cl. H01M 8/04119

(52) U.S. Cl. CPC H01M 8/04149

(57) ABSTRACT

A humidifier module is provided having a water vapor-permeable membrane having spacers defining a flow field arranged on either side of the membrane and having a yarn stitched into the membrane. The spacers defining the flow field are formed by the yarn stitched into the membrane. A humidifier, a method for making a humidifier module and a method for making a humidifier are also provided.

### BACKGROUND

### Technical Field

Embodiments of the invention relate to a humidifier module having a water vapor-permeable membrane, having spacers each defining a flow field arranged on either side of the membrane, and having a yarn stitched into the membrane.

Embodiments of the invention furthermore relate to a humidifier and a method for making a humidifier module, as well as a method for making a humidifier.

### Description of the Related Art

Humidifiers are generally used in the case of two gaseous media having a different moisture content to bring about a transfer of moisture to the dryer medium. Such gas/gas humidifiers find application in particular in fuel cell devices, where air with the oxygen contained therein is compressed in the cathode circulation in order to supply the cathode spaces of the fuel cell stack, so that relatively warm and dry compressed air is present, the moisture content of which is not sufficient for the membrane for use in the fuel cell stack. The dry air provided by the compressor is humidified for the fuel cell stack by moving it along the water vapor-permeable membrane whose other side is exposed to the humid exhaust air from the fuel cell stack. Furthermore, liquid water accrues in the fuel cell stack both at the anode side and at the cathode side and it must be removed from the fuel cell stack. The humidifier, the water separator, and the intercooler positioned downstream from the compressor are large components, contributing to a large increase in the design space needed for a fuel cell device and curtailing the efficiency of the fuel cell device, because large thermal losses are present.

U.S. Pat. No. 9,806,362 B2 discloses a planar humidifier having a plurality of humidifier units comprising membranes, with a yarn stitched into a margin region of the membrane at the periphery in order to seal off the humidifier unit from the outside.

Furthermore, proposals are known for using a humidifier having a plurality of humidifier modules possessing webs which define a flow field, thereby making possible a more uniform washing of the membrane with the medium occurring on this side. In such humidifiers, the humidifier modules are clamped together by means of tie rods. The humidifier modules have a repeating stack structure consisting of a seal, a flow field frame, another seal, a membrane, another seal, another flow field frame, and once again a seal. The production of such a humidifier module or a humidifier constructed from a plurality of such humidifier modules is relatively expensive and thus involves high costs.

### BRIEF SUMMARY

Embodiments described herein provide a humidifier module, a humidifier, a method for making a humidifier module and a method for making a humidifier by which the aforementioned shortcomings are reduced.

The humidifier module is characterized in particular in that the spacers defining the flow field are formed by the yarn stitched into the membrane. Thanks to the stitched yarn, the membrane is given a supporting and especially a stiffening skeletal structure. The yarn can form a flow field on both sides. Consequently, no additional components are needed, such as the otherwise customary spacers fashioned as webs. This makes possible a more cost-effective production of the humidifier module and at the same time a savings in weight. In this regard, it is provided in particular that the yarn has a material thickness or a diameter of 0.2 mm to 4 mm, such as a material thickness between 0.25 mm and 3 mm. The yarn must be formed stiff enough to assure the air flow in the humidifier module and to reduce pressure losses within the humidifier module.

The yarn can be led through the membrane in one especially simple embodiment such that at least one yarn top piece is arranged on a first side of the membrane and at least one yarn bottom piece is arranged on a second side of the membrane.

In this regard, it is advantageous for the yarn or an additional yarn to be led through the membrane such that one or more of the yarn top pieces and/or one or more of the yarn bottom pieces are joined together at nodal points. This strengthens the skeletal structure of the membrane.

In an alternative embodiment, the yarn is formed as a top thread and an additional yarn is formed as a bottom thread, while the top thread is joined to or interwoven with the bottom thread at one or more nodal points. The spacers in this case may be formed similar to a lockstitch, i.e., the top thread and the bottom thread are interwoven with each other at the nodal points by inserting the bottom thread through a loop of the top thread.

In order to seal off the humidifier module and especially the flow field, the yarn and/or the additional yarn may be formed from a thermoplastic material, and at least some of the nodal points may be fusible by means of the action of heat in order to form a seal. In particular, it is advantageous for all nodal points to be fusible by means of the action of heat.

In an especially simple embodiment of the humidifier module, the additional yarn can be stretched above the yarn top piece and below the yarn bottom piece such that the yarn top piece or the loops of the yarn top piece of the yarn touch the additional yarn at least at one nodal point. At this nodal point, the yarn may be fused to the additional yarn by means of the action of heat. This holds analogously for the additional yarn, which touches the yarn bottom pieces, i.e., the loops of the yarn bottom pieces, at least at one nodal point.

Alternatively, the yarn or the additional yarn can be led staggered through the membrane such that one loop of a yarn top piece of the additional yarn is arranged between two loops of the yarn top piece of the yarn.

In a further embodiment in which the yarn is formed as a top thread and the additional yarn is formed as a bottom thread, the bottom thread is interwoven with a top thread loop formed by the top thread. The nodal points formed in this way, or certain of these nodal points, are fusible by means of the action of heat.

It is especially advantageous for the yarn and the additional yarn to have different melting points. If the yarn has a lower melting point than the additional yarn, then the yarn can be fused to the additional yarn starting at the melting temperature of the yarn, without the additional yarn also melting. In other words, the melting temperature of the yarn or that of the additional yarn can be chosen such that only one of the two yarns begins to melt or develops adhesive properties at this temperature. The chosen melting temperature will of course lie below a melting temperature of the membrane material. This holds analogously for the case when the additional yarn has the lower melting point than the yarn.

Alternatively or additionally, one of the yarns may be formed from a material, which may be a thermoplastic material, having a wick effect. In other words, liquid can be taken up or sucked up into this yarn by means of the wick effect and thus be stored at least partly in the yarn. The yarn with wick effect that is led through the membrane forms a kind of liquid bridge between the dry and the wet side of the membrane.

In order to also seal off the humidifier module at the outer circumference, it is advantageous for a further yarn to be stitched into a margin region of the membrane at least partly on the circumference or to be applied to the margin region. The further yarn here may be formed from an elastomer. The elastomer may comprise or consist of silicone or EPDM, for example, so that an additional sealing effect is achieved by a stretching or clamping of the further yarn.

The humidifier is characterized in particular in that a plurality of humidifier modules are provided and arranged between two end plates. The humidifier modules may be fused together by means of the action of heat, so that an outwardly acting seal of the humidifier modules is also achieved. The benefits mentioned in the context of the humidifier module are also applicable to the humidifier and therefore hold accordingly for it.

The method for making a humidifier module involves in particular the following steps:
providing a membrane and
stitching a yarn into or applying a yarn on the membrane such that the yarn forms a spacer defining a flow field.

This enables an especially simple and cost-effective production of the humidifier module.

In this context, it is provided in particular that the yarn is stitched into the membrane in a plurality of parallel running rows or applied on the membrane in a plurality of parallel running rows.

In order to seal off the flow fields, the method involves in particular the following steps:
fusing of at least some of the nodal points created by the joining of one or more yarn top pieces and/or one or more yarn bottom pieces by means of the action of heat, or
fusing of at least some of the nodal points created by the joining of a top thread to a bottom thread by means of the action of heat.

In order to also seal off the humidifier module at the periphery, the method may include:
stitching or applying a further yarn into a margin region of the membrane at least partly on the circumference.

The method for making a humidifier is characterized in particular by the following steps:
providing a plurality of humidifier modules,
fusing the humidifier modules together by the action of heat,
arranging the plurality of fused humidifier modules between two end plates and
clamping the humidifier modules to the end plates by means of tie rods.

In such a humidifier, no additional layers or components are necessary, such as a flow field frame, a sealing frame, or an additional seal. The humidifier module and also the humidifier may thus be constructed solely from a multitude of membranes in which yarns are stitched or on which yarns are applied in order to create a flow field which is sealed off from the outside or at the circumference.

### BRIEF DESCRIPTION OF THE SEVERAL VIEWS OF THE DRAWINGS

Further benefits, features and details will emerge from the claims, the following detailed description, and the drawings.

FIG. 1 illustrates a schematic top view of a humidifier module.

FIG. 2 illustrates a schematic cross-sectional view of a first embodiment of a humidifier module.

FIG. 3 illustrates a schematic cross-sectional view of a second embodiment of a humidifier module.

FIG. 4 illustrates a schematic cross-sectional view of a third embodiment of a humidifier module.

FIG. 5 illustrates a schematic cross-sectional view of a fourth embodiment of a humidifier module.

FIG. 6 illustrates a humidifier.

### DETAILED DESCRIPTION

Fuel cells are used for generating energy and can be employed in particular for generating energy for the propulsion of motor vehicles. In some embodiments, a multitude of fuel cells is assembled into a fuel cell stack.

Each of the fuel cells comprises an anode, a cathode as well as a proton-conductive polymer membrane separating the anode from the cathode. The polymer membrane is formed from an ionomer, such as a sulfonated tetrafluorethylene polymer (PTFE) or a polymer of perfluorinated sulfonic acid (PFSA). Alternatively, the polymer membrane can be formed as a hydrocarbon membrane.

In addition, a catalyst may be blended in with the anodes and/or the cathodes, the membrane being coated on its first side and/or on its second side with a catalyst layer consisting of a precious metal or a mixture containing precious metals such as platinum, palladium, ruthenium or the like, which serve as a reaction accelerant in the reaction of the particular fuel cell.

The anode fuel (such as hydrogen) may be supplied via an anode space. In a polymer electrolyte membrane fuel cell (PEM fuel cell), fuel or fuel components are split into protons and electrons at the anode. The PEM lets the protons through, but is impermeable to the electrons. For example, the reaction 2H₂→4H⁺+4e⁻ (oxidation/electron donation) will occur at the anode. While the protons pass through the PEM and go to the cathode, the electrons are taken by an external circuit to the cathode or to an energy accumulator.

The cathode gas (such as oxygen or air containing oxygen) can be supplied to the cathode via a cathode space, so that the following reaction will occur at the cathode side: O₂+4H⁺+4e⁻→2H₂O (reduction/electron uptake).

In order to assure an ion conductivity for hydrogen protons through the PEM, the presence of water molecules in the PEM is necessary. Therefore, the cathode gas in particular is humidified before being supplied to the fuel cell, in order to bring about a moisture saturation of the PEM.

Since multiple fuel cells are placed together in the fuel cell stack, a sufficiently large quantity of cathode gas must be provided, so that a large mass flow of cathode gas is produced by a compressor, and due to the compressing of the cathode gas its temperature is greatly raised. The conditioning of the cathode gas, i.e., its adjustment in regard to the desired parameters in the fuel cell stack, is done in an intercooler as well as a humidifier 4.

The humidifier 4 represented as an embodiment in FIG. 6 has two end plates 5, between which are arranged a plurality of humidifier modules 6, the humidifier modules 6 being clamped between the end plates 5 by the tie rods 7. A different joining of the end plates 5, instead of the tie rods 7, is likewise conceivable by the use of bands, for example.

In the embodiment shown, for a more simplified drawing, the media ports 8 for the supply and the removal of the two media have been assigned to one of the end plates 5, while in the case of a fuel cell device the two media differ only in regard to their moisture content, but air is generally physically present. However, in general the possibility exists of arranging the media ports 8 for one of the media jointly on one of the end plates 5 or separately on both end plates 5 and arranging the media ports 8 for the other medium jointly on the same end plate or the other end plate as the media ports 8 for the first medium or separately on both end plates 5 with an inverted assignment of the media ports 8 for the supply and for the removal in regard to the first medium, i.e., the also humidifier modules 6 arranged in a row can experience a U or Z-shaped flow in regard to a medium, and when the two media are considered jointly a counterflow or a crossing counterflow is also possible.

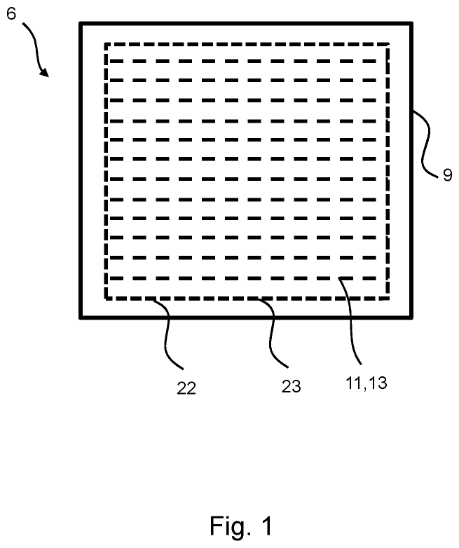

FIG. 1 shows the layout of an individual humidifier module 6. On either side of the membrane 9 here there is arranged a flow field defined by spacers 11. The spacers 11 are formed by a yarn 13 stitched into the membrane 9, giving the membrane 9 a kind of skeletal structure. In FIG. 1, a plurality of parallel running rows of yarn 13 are stitched into the membrane 9, forming the spacers 11 defining the flow field.

Furthermore, a further yarn 22 is stitched into a margin region 23 of the membrane 9 at the circumference or applied onto the margin region 23. This enables a circumferential sealing of the humidifier module 6. In particular when the further yarn 22 is formed as an elastomer, this additional sealing action is achieved upon tightening or bracing the further yarn 22.

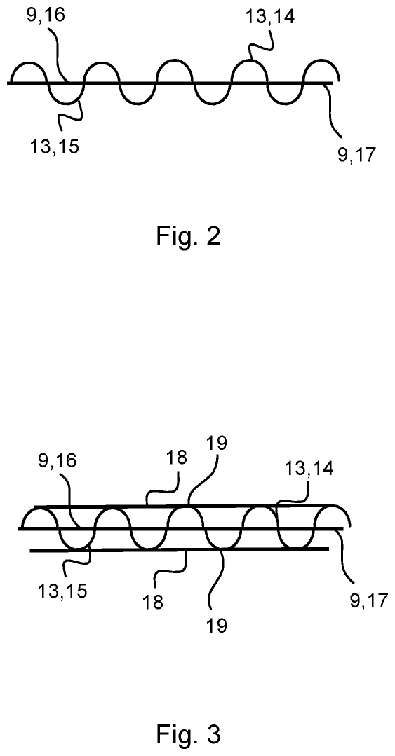

FIGS. 2 to 5 show various embodiments of the yarns 13 stitched into the membrane 9 or applied onto the membrane 9. In FIG. 3, the yarn 13 is led through the membrane 9 such that at least one yarn top piece 14 is arranged on a first side 16 and at least one yarn bottom piece 15 is arranged on a second side 17 of the membrane 9. The yarn top pieces 14 and the yarn bottom pieces 15 are consequently formed as a plurality of loops. Between the yarn top pieces 14 and the yarn bottom pieces 15 is arranged the flow field, so that the yarn top pieces 14 and the yarn bottom pieces 15 each form spacers 11.

FIG. 3 shows another embodiment, in which the flow field is additionally sealed off. For this, an additional yarn 18 is placed on the yarn top pieces 14 and the yarn bottom pieces 15 such that the additional yarn 18 lies at least for a section on the yarn 13, or on the yarn top pieces 14 or the yarn bottom pieces 15. At these nodal points 19 formed as bearing points, the additional yarn 18 can be fused to the yarn 13 by means of the action of heat if either the additional yarn 18 or the yarn 13 or both of them are formed from a thermoplastic material. The additional yarn 18 here may have a lower melting point than that of the yarn 13. At least the additional yarn 18 is formed here as a thermoplastic. The yarn 13, formed from a synthetic material, or from cotton or from hemp or from wool or the like, has a wicking action, so that liquid is taken up from the flow field by the yarn 13 and can be stored at least temporarily in it, the transport of the liquid from the wet side of the membrane 9 to the dry side of the membrane 9 being favored by the wick effect of the yarn 13. The yarn 13 with wick effect which is led through the membrane 9 thus forms a liquid bridge at each passage through the membrane 9.

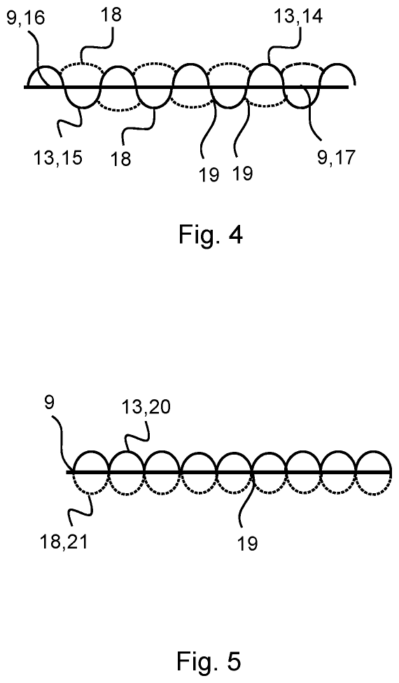

FIG. 4 shows another embodiment, differing from the preceding one in that the additional yarn 18 is likewise stitched into the membrane 9 and this is led through the membrane 9 such that one or more of the yarn top pieces 14 and/or one or more of the yarn bottom pieces 15 are joined together at nodal points 19. These nodal points 19 or certain of the nodal points 19 may be fused together by means of the action of heat, in order to seal the flow field.

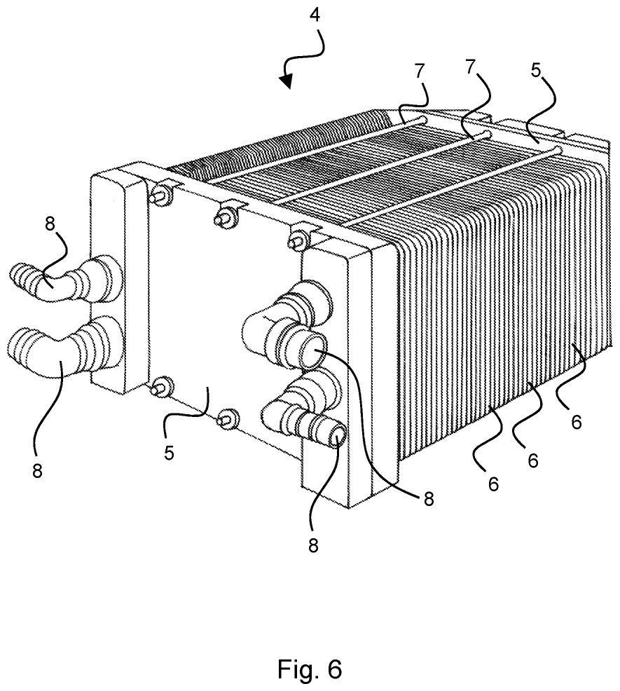

FIG. 5 shows another embodiment of the humidifier module 6, where the yarn 13 is formed as a top thread 20, while the additional yarn 18 is formed as a bottom thread 21. The top thread 20 and the bottom thread 21 are stitched into the membrane 9 like a lockstitch, so that a top thread loop of the top thread 20 is interwoven with the bottom thread 21 to form a nodal point 19. These nodal points 19 in turn can be fused together by means of the action of heat in order to achieve an additional sealing action.

The method for making the humidifier module 6 involves in particular the following steps: first, a membrane 9 is provided. A yarn 13 is stitched into the membrane 9 such that the yarn 13 forms at least two spacers 11 defining a flow field. Alternatively, the yarn 13 may be applied on the membrane 6 such that the yarn 13 forms at least two spacers 11 defining the flow field. The application can be done for example by means of 3-D printing methods.

The stitching of the yarn 13 into the membrane 9 or the application of the yarn 13 onto the membrane 9 is done in a plurality of parallel running rows. This makes it possible to create an especially large flow field. Furthermore, in order to achieve a sealing action, the yarn top pieces 14 and the yarn bottom pieces 15 can be fused to the additional yarn 18 at the nodal points 19. Alternatively, the nodal points 19 created by interweaving the top thread 20 with the bottom thread 21 can also be fused by means of the action of heat.

Alternatively or additionally, a further yarn 22 can be stitched into the margin region 23 of the membrane 9 at least for a section on the circumference. This enables an additional outer circumferential sealing of the humidifier module 6.

The method for making the humidifier 4 involves in particular the following steps: first, a plurality of humidifier modules 6 is provided. The humidifier modules 6 are fused together by means of the action of heat. In this way, the humidifier modules 6 are sealed against the outside. Furthermore, the plurality of fused-together humidifier modules 6 is arranged between the two end plates 5. By means of the tie rods 7, the humidifier modules are finally clamped with the end plates 5. It should be pointed out that a fusing of the nodal points 19 or the individual yarns 13, 18, 22 can also be produced by the mere clamping of the end plates 5. Thus, this corresponds to a cold forming of the yarns 13, 18, 22 or the nodal points 19 formed by them.

In general, in the following claims, the terms used should not be construed to limit the claims to the specific embodiments disclosed in the specification and the claims, but should be construed to include all possible embodiments along with the full scope of equivalents to which such claims are entitled.

1. A humidifier module, comprising:
a water vapor-permeable membrane having spacers defining a flow field arranged on either side of the membrane,
and wherein the spacers defining the flow field are formed by a yarn stitched into the membrane.

2. The humidifier module according to claim 1, wherein the yarn extends through the membrane such that at least one yarn top piece is arranged on a first side of the membrane and at least one yarn bottom piece is arranged on a second side of the membrane.

3. The humidifier module according to claim 2, wherein the yarn or an additional yarn extends through the membrane such that one or more of the yarn top pieces and/or one or more of the yarn bottom pieces are joined together at nodal points.

4. The humidifier module according to claim 1, wherein the yarn is formed as a top thread, an additional yarn is formed as a bottom thread, and the top thread is joined to or interwoven with the bottom thread at least at one nodal point.

5. The humidifier module according to claim 3, wherein the yarn and/or the additional yarn is formed from a thermoplastic material, and at least some of the nodal points are fusible by the action of heat in order to form a seal.

6. The humidifier module according to claim 5, wherein the yarn and the additional yarn have different melting points.

7. The humidifier module according to claim 1, wherein a further yarn is stitched into a margin region of the membrane at least partly on a circumference or is applied to the margin region.

8. A humidifier having a plurality of humidifier modules according to claim 1 arranged between two end plates.

9. A method for making a humidifier module including a water vapor-permeable membrane having spacers defining a flow field arranged on either side of the membrane, wherein the spacers defining the flow field are formed by a yarn stitched into the membrane, the method comprising:
providing a membrane, and
stitching a yarn into or applying a yarn on the membrane such that the yarn forms a spacer defining a flow field.

10. A method for making a humidifier having a plurality of humidifier modules arranged between two end plates, each of the humidifier modules including a water vapor-permeable membrane having spacers defining a flow field arranged on either side of the membrane, wherein the spacers defining the flow field are formed by a yarn stitched into the membrane, the method comprising:
providing a plurality of humidifier modules;
fusing the humidifier modules together by the action of heat;
arranging the plurality of fused humidifier modules between two end plates; and
clamping the humidifier modules to the end plates by tie rods.
